(19) United States
(12) Patent Application Publication
(10) Pub. No.: US 2026/0074516 A1
(43) Pub. Date: Mar. 12, 2026

(54) VSG Frequency Control Method, Device and Storage Medium Based on Power Correction

(71) Applicants: DATANG BOILER PRESSURE VESSEL INSPECTION CENTER CO., LTD., Hefei (CN); CHINA DATANG CORPORATION SCIENCE AND TECHNOLOGY GENERAL RESEARCH INSTITUTE CO.LTD EAST CHINA ELECT, Hefei (CN); ZHEJIANG DATANG INTERNATIONAL RENEWABLE POWER CO., LTD., Hangzhou (CN); GUANGDONG DATANG INTERNATIONAL CHAOZHOU POWER GENERATION CO., LTD., Chaozhou (CN)

(72) Inventors: Xing Wang, Hefei (CN); Jiazhu WEI, Hefei (CN); Liang LOU, Hefei (CN); Chaonan ZHANG, Hefei (CN); Tianpeng YU, Hefei (CN); Ping WANG, Hefei (CN); Miao ZHAO, Hefei (CN); Yulei YANG, Hefei (CN)

(21) Appl. No.: 19/275,980

(22) Filed: Jul. 22, 2025

Related U.S. Application Data
(63) Continuation of application No. PCT/CN2024/127824, filed on Oct. 28, 2024.

(30) Foreign Application Priority Data
Dec. 21, 2023 (CN) 202311781350.1

(51) Int. Cl. H02J 3/24; G05B 13/04

(52) U.S. Cl. CPC H02J 3/00142; G05B 13/042

(57) ABSTRACT

VSG Frequency Control Method, Device and Storage Medium based on Power Correction, belonging to the field of power electronics technology, which addresses the problem of suppressing VSG output power oscillations. The technical solution of the present application corrects the output power Pₑ(s) and feeds the corrected value back to the control loop to suppress power oscillations. The transfer function of the power correction stage G(s) is flexible and can be configured with appropriate parameters according to the system's inherent phase margin. Additionally, principles for selecting the parameters of the correction coefficients τ₁ and τ₂ are also provided. The adjustment coefficients of the power correction stage, the values of τ₁ and τ₂ do not affect the effect of the steady-state gain during the transient process. The present application can not only suppress VSG output power oscillations, but also provide a larger inertial support, thereby improving the stability of the VSG system.

### TECHNICAL FIELD

The present application belongs to the field of power electronics technology and relates to a Virtual Synchronous Generator (VSG) frequency control method, device and storage medium based on power correction.

### BACKGROUND

Virtual Synchronous Generator (VSG) technology is a novel power generation technology based on power electronics technology. Its emergence has provided new ideas and development directions for power system advancement. Through the application of Virtual Synchronous Generator technology, power generation and operation of power systems can become more flexible and efficient. Currently, Virtual Synchronous Generator technology has been widely applied in various fields including renewable energy power generation, ultra-high voltage transmission, and market-oriented power trading. In future development, Virtual Synchronous Generator technology will continue to exert its advantages, bringing new opportunities and challenges to the power industry.

Currently, the renewable energy industry is flourishing, and power generation from renewable energy sources interfaced through power electronic devices is increasing year by year. However, the grid connection of multiple converters leads to reduced power system inertia, which can easily trigger system instability. To address issues such as the widespread decline of inertia in modern power systems, Virtual Synchronous Generator (VSG) technology is widely applied in distributed systems.

The Virtual Synchronous Generator simulates the rotor motion formula of the Synchronous Generator (SG), providing inverters with virtual inertia and damping characteristics, which is beneficial for enhancing system inertia and frequency stability. However, the introduction of the rotor swing formula also makes Virtual Synchronous Generator (VSG) have oscillation characteristics similar to Synchronous Generator (SG). If parameters such as virtual inertia and damping coefficient are set improperly, the VSG may experience power oscillation problems such as “electromechanical-like” oscillations.

### SUMMARY

The present application addresses the problem of how to suppress output power oscillations in Virtual Synchronous Generators (VSG).

The present application solves the aforementioned technical problems through the following technical solution:

A VSG frequency control method based on power correction, comprising the following steps:
obtaining an output power Pₑ(s) in the VSG control loop, multiplying the out power by a transfer function G(s) of a correction stage, and feeding it back to a frequency generation stage of an active power-frequency control loop, wherein Pₑ(s) refers to an output power at a VSG grid connection point, obtained through sampling and calculation;
S2. obtaining a frequency ω according to the active power-frequency control stage in the VSG control loop, and compensating the frequency generation stage from the step S1 into the control loop to obtain a compensated frequency ω*;
S3. designing the parameters of coefficients τ₁ and τ₂ in the transfer function G(s) of the power correction stage based on the transfer function G(s) of the power correction stage and in combination with the phase margin requirements of a system open-loop transfer function.

Furthermore, a calculation formula of the output power Pₑ(s) is:

$${P}_{e} ( s ) = \frac{3}{2} ( {e}_{d} {i}_{d} + {e}_{q} {i}_{q} ) \qquad ( 1 )$$

wherein e_{d}, e_{q}, i_{d}, and i_{q} are the d-axis and q-axis components of the voltage and current at the sampling point PCC after abc/dq0 transformation, and s is the transformation parameter in the Laplace transform.

Furthermore, the expression of the frequency ω is:

$$ω = ( {P}_{r e f} ( s ) - {P}_{e} ( s ) ) \frac{1}{J {ω}_{0} s + {D}_{p} {ω}_{0}} + {ω}_{0} \qquad ( 2 )$$

wherein J is a virtual inertia coefficient, Dₚ is a damping coefficient, P_{ref}(s) is a reference power, and do is a grid rated angular frequency.

Furthermore, the expression of the compensated frequency ω* is:

$${ω}^{*} = ( {P}_{r e f} ( s ) - {P}_{e} ( s ) ) \frac{1}{J {ω}_{0} s + {D}_{p} {ω}_{0}} + {ω}_{0} - {P}_{e} ( s ) G ( s ) \qquad ( 3 )$$

wherein G(s) is a transfer function of the correction stage.

Furthermore, the expression of transfer function of the correction stage is:

$$G ( s ) = \frac{- {τ}_{2} s}{( 1 + {τ}_{1} s + {τ}_{2} s ) {G}_{2} ( s )} \qquad ( 4 )$$

wherein τ₁ and τ₂ are regulation coefficients of the power correction stage, and G₂(s) is a transfer function from an angular frequency Δω in a Virtual Synchronous Generator (VSG) small-signal model to output power Pₑ(s).

Furthermore, the expression of the transfer function G₂(s) from the angular frequency Δω in the Virtual Synchronous Generator (VSG) small-signal model to output power Pₑ(s) is:

$${G}_{2} ( s ) = \frac{{K}_{s} ( s )}{s} = \frac{\frac{3 E {U}_{g}}{\sqrt{{( s {L}_{X} + {R}_{X} )}^{2} + {( {ω}_{0} {L}_{X} )}^{2}}}}{s} \qquad ( 5 )$$

wherein, L_{X} is the sum of filter inductance L_{f} and transmission line inductance L_{g}, Rₓ is the sum of the resistances in transmission line, E is a VSG output voltage amplitude, and U_{g} is a grid-side voltage.

Furthermore, the expression of the system open-loop transfer function is:

$${G}_{open} ( s ) = \frac{1}{( J {ω}_{0} s + {D}_{p} {ω}_{0} )} {G}_{2} ( s ) \frac{1 + ( {τ}_{1} + {τ}_{2} ) s}{1 + {τ}_{1} s} \qquad ( 6 )$$

wherein the system's phase margin is expressed as:

$$P M = 180 ° + ∠ [ {G}_{open} ( s ) ] \qquad ( 7 )$$

wherein using the system's phase margin as an indicator to design the parameters of the adjustment coefficients τ₁ and τ₂ of the power correction stage.

Furthermore, the process for designing the parameters of the adjustment coefficients τ₁ and τ₂ of the power correction stage is as follows:
equivalently representing the power correction stage as a lead-lag compensator, with its characteristic expressed as:

$$\{ \begin{matrix}φ ( {ω}_{m} ) = arc tan \frac{\frac{{τ}_{2}}{{τ}_{1}}}{2 \sqrt{\frac{{τ}_{1} + {τ}_{2}}{{τ}_{1}}}} \\ {ω}_{m} = \frac{1}{{τ}_{1} \sqrt{\frac{{τ}_{1} + {τ}_{2}}{{τ}_{1}}}}\end{matrix} \qquad ( 8 )$$

wherein, φ(ωₘ) is a maximum lead angle provided by the power correction stage, and ωₘ is an angular frequency corresponding to the maximum lead angle;
wherein the cutoff frequency and system's phase margin can be derived from formula (6), with the expression shown in formula (9):

$$\{ \begin{matrix}\vert \frac{\vert {G}_{2} ( s ) \vert \sqrt{{( ( {τ}_{1} + {τ}_{2} ) {ω}_{c} )}^{2} + 1}}{\sqrt{{( J {ω}_{0} {ω}_{c} )}^{2} + {( {D}_{p} {ω}_{0} )}^{2}} \cdot \sqrt{{( {τ}_{1} {ω}_{c} )}^{2} + 1}} \vert = 1 \\ γ = 180 ° - arctan \frac{J {ω}_{c}}{{D}_{p}} + ∠ {G}_{2} ( {ω}_{c} ) + φ ( {ω}_{c} )\end{matrix} \qquad ( 9 )$$

wherein ω_{c} is the cutoff frequency of the VSG system after adding active power correction, φ(ω_{c}) is the corresponding phase angle at this cutoff frequency after adding power correction, the specific expression is:

$$φ ( {ω}_{c} ) = arctan \frac{{τ}_{2} {ω}_{c}}{1 + {τ}_{1} ( {τ}_{1} + {τ}_{2} ) {ω}_{c}^{2}} \qquad ( 10 )$$

setting ω_{c}=ωₘ, and substituting formulas (8) and (10) into formula (9) to obtain the binary formula s for τ₁ and τ₂ as shown in formulas (11) and (12):

$${τ}_{1} = \sqrt{\frac{\begin{matrix}{D}_{p}^{2} \frac{{τ}_{1} + {τ}_{2}}{{τ}_{1}} + \\ \sqrt{{( {D}_{p} {ω}_{0} )}^{4} {( \frac{{τ}_{1} + {τ}_{2}}{{τ}_{1}} )}^{2} + 4 {\vert {G}_{2} ( s ) \vert}^{2} {( \frac{{τ}_{1} + {τ}_{2}}{{τ}_{1}} )}^{3} {( J {ω}_{0} )}^{2}}\end{matrix}}{2 {\vert {G}_{2} ( s ) \vert}^{2} {( \frac{{τ}_{1} + {τ}_{2}}{{τ}_{1}} )}^{3}}} \qquad ( 11 )$$

$${τ}_{1} = \frac{J {ω}_{0}}{{D}_{p} {ω}_{0}} \frac{2 {( \frac{{τ}_{1} + {τ}_{2}}{{τ}_{1}} )}^{\frac{1}{2}}}{{( \frac{{τ}_{1} + {τ}_{2}}{{τ}_{1}} )}^{\frac{3}{2}} + 2 cot γ - {( \frac{{τ}_{1} + {τ}_{2}}{{τ}_{1}} )}^{\frac{1}{2}}} \qquad ( 12 )$$

selecting the phase margin γ, combine formula s (11) and (12) to determine the specific values of parameters τ₁ and τ₂.

An electronic device, comprising a memory and a processor, wherein the memory stores a program that enables the processor to execute the aforementioned Virtual Synchronous Generator (VSG) frequency control method based on power correction, and the processor is configured to execute the program stored in the memory.

A storage medium storing a computer program, wherein when the computer program is executed by a processor, it performs the steps of the aforementioned Virtual Synchronous Generator (VSG) frequency control method based on power correction.

The advantages of the present application are:

The technical solution of the present application corrects the output power Pₑ(s) and feeds the corrected value back to the control loop to suppress power oscillations. The expression of the power correction stage G(s) is flexible and can be configured with appropriate parameters according to the system's phase margin. Additionally, principles for selecting the correction coefficients τ₁ and τ₂ are provided. The adjustment coefficients of the power correction stage τ₁ and τ₂ do not affect the steady-state gain during the transient process; The present application can both suppress Virtual Synchronous Generator (VSG) output power oscillations and provide greater inertial support, improving the stability of the VSG system; and compared with VSG systems without correction, the system's anti-interference performance is significantly improved after adding correction, with substantially enhanced capability to suppress overshooting.

### BRIEF DESCRIPTION OF THE DRAWINGS

FIG. 1 is a Flowchart of the VSG frequency control method based on power correction;

FIG. 2 is a VSG main circuit topology and control structure;

FIG. 3 is a VSG active power-frequency control stage without correction;

FIG. 4 is a VSG active power-frequency control stage with power correction stage;

FIG. 5 is a VSG main circuit topology and control structure with power correction stage;

FIG. 6(a) is an operating condition under a reference power impact;

FIG. 6(b) is an operating condition under a reference power step;

FIG. 6(c) is an operating condition under a grid angular frequency step;

FIG. 7(a) is a VSG output power response during reference power impact;

FIG. 7(b) is a VSG output angular frequency response during reference power impact;

FIG. 8(a) is a VSG output power response during reference power step;

FIG. 8(b) is a VSG output angular frequency response during reference power step;

FIG. 9(a) is a VSG output power response during grid angular frequency step;

FIG. 9(b) is a VSG output angular frequency response during grid angular frequency step.

### DETAILED DESCRIPTION

To make the purpose, technical solution, and advantages of the embodiments of the present application clearer, the following will provide a clear and complete description of the technical solutions in the embodiments of the present application. Obviously, the described embodiments represent only a portion of the embodiments of the present application, not all possible embodiments. Based on the embodiments in the present application, all other embodiments obtained by ordinary skilled practitioners in the field without creative effort also fall within the protection scope of the present application.

The following further describes the technical solution of the present application in combination with the specification drawings and specific embodiments:

### Embodiment 1

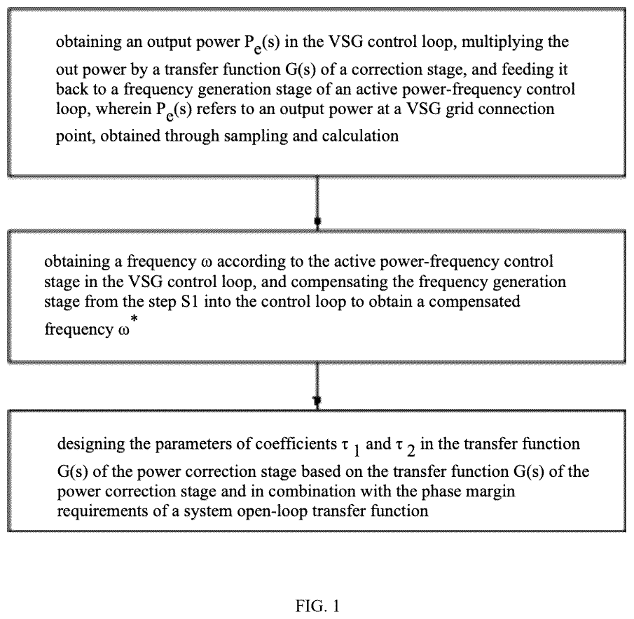

As shown in FIG. 1, the Virtual Synchronous Generator (VSG) frequency control method based on power correction in this embodiment comprises the following steps:
Step 1: obtaining an output power Pₑ(s) in the VSG control loop, multiplying the out power by a transfer function G(s) of a correction stage, and feeding it back to a frequency generation stage of an active power-frequency control loop, thereby suppressing power oscillations and increasing system robustness, wherein Pₑ(s) refers to an output power at a VSG grid connection point, obtained through sampling and calculation;
Step 2: obtaining a frequency ω according to the active power-frequency control stage in the VSG control loop, and compensating the frequency generation stage from the step S1 into the control loop to obtain a compensated frequency ω*;
Step 3: designing the parameters of coefficients τ₁ and τ₂ in the transfer function G(s) of the power correction stage based on the transfer function G(s) of the power correction stage and in combination with the phase margin requirements of a system open-loop transfer function.

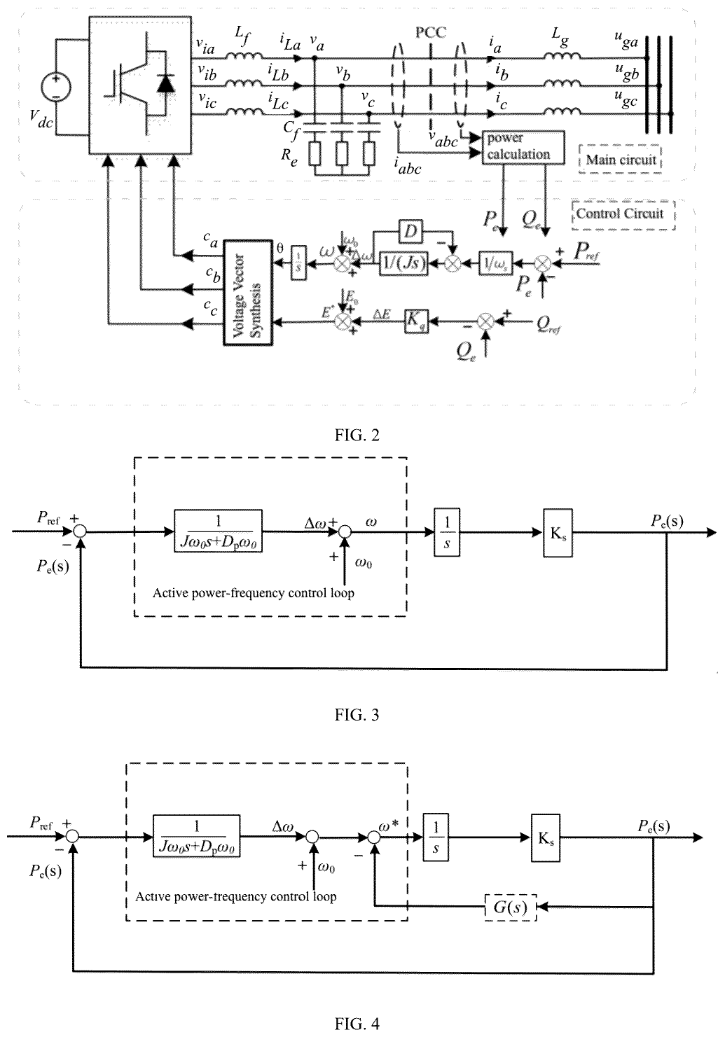

FIG. 2 illustrates the main circuit topology and control structure of the embodiment based on the Virtual Synchronous Generator (VSG) power correction strategy in the present application, wherein a calculation formula of the output power Pₑ(s) is shown in formula (1):

$${P}_{e} ( s ) = \frac{3}{2} ( {e}_{d} {i}_{d} + {e}_{q} {i}_{q} ) \qquad ( 1 )$$

wherein e_{d}, e_{q}, i_{d}, and i_{q} are the d-axis and q-axis components of the voltage and current at the sampling point PCC after abc/dq0 transformation, and s is the transformation parameter in the Laplace transform.

FIG. 3 shows the small-signal model of the VSG. According to the active power-frequency control stage in the VSG small-signal model, the expression for frequency ω can be obtained as shown in formula (2):

$$ω = ( {P}_{ref} ( s ) - {P}_{e} ( s ) ) \frac{1}{J {ω}_{0} s + {D}_{p} {ω}_{0}} + {ω}_{0} \qquad ( 2 )$$

wherein J is a virtual inertia coefficient, Dₚ is a damping coefficient, P_{ref}(s) is a reference power, and ω₀ is a grid rated angular frequency.

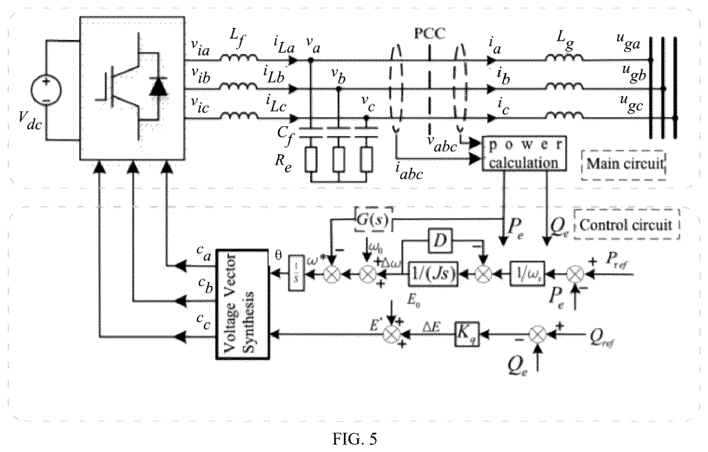

Adding the frequency generation stage of the active power-frequency control loop mentioned in Step 1 to the VSG control loop to obtain the VSG active power-frequency control stage shown in FIG. 4. The expression of the compensated frequency ω* is obtained as shown in formula (3):

$${ω}^{*} = ( {P}_{ref} ( s ) - {P}_{e} ( s ) ) \frac{1}{J {ω}_{0} s + {D}_{p} {ω}_{0}} + {ω}_{0} - {P}_{e} ( s ) G ( s ) \qquad ( 3 )$$

The corresponding Virtual Synchronous Generator (VSG) main circuit topology and control structure are shown in FIG. 5.

The expression of the transfer function G(s) of the correction stage in step 3 is:

$$G ( s ) = \frac{- {τ}_{2} s}{( 1 + {τ}_{1} s + {τ}_{2} s ) {G}_{2} ( s )} \qquad ( 4 )$$

wherein τ₁ and τ₂ are regulation coefficients of the power correction stage, and G₂(s) is a transfer function from an angular frequency Δω in a Virtual Synchronous Generator (VSG) small-signal model to output power Pₑ(s), with its expression shown in formula (5):

$${G}_{2} ( s ) = \frac{{K}_{s} ( s )}{s} = \frac{\frac{3 E {U}_{g}}{\sqrt{{( s {L}_{X} + {R}_{X} )}^{2} + {( {ω}_{0} {L}_{X} )}^{2}}}}{s} \qquad ( 5 )$$

In the formula, L_{X} is the sum of filter inductance L_{f} and transmission line inductance L_{g}, R_{X} is the sum of the resistances in transmission line, E is a VSG output voltage amplitude, and U_{g} is a grid-side voltage.

After adding the frequency generation stage, according to FIG. 4 and combining formula s (4) and (5), the open-loop transfer function of the system can be represented by formula (6):

$${G}_{open} ( s ) = \frac{1}{( J {ω}_{0} s + {D}_{p} {ω}_{0} )} {G}_{2} ( s ) \frac{1 + ( {τ}_{1} + {τ}_{2} ) s}{1 + {τ}_{1} s} \qquad ( 6 )$$

At this point, the system's phase margin can be expressed as:

$$P M = 180 ° + ∠ [ {G}_{open} ( s ) ] \qquad ( 7 )$$

From formula (7), it can be seen that the system's phase margin PM can be used as an indicator to design the regulation coefficients τ₁ and τ₂ in the power correction stage in formula (6).

The design process for the coefficients τ₁ and τ₂ in the correction stage G(s) is as follows:

The correction strategy based on power correction feedback mentioned in the present application can be equivalent to a lead-lag compensator, whose characteristics can be expressed as:

$$\{ \begin{matrix}φ ( {ω}_{m} ) = arctan \frac{\frac{{τ}_{2}}{{τ}_{1}}}{2 \sqrt{\frac{{τ}_{1} + {τ}_{2}}{{τ}_{1}}}} \\ {ω}_{m} = \frac{1}{{τ}_{1} \sqrt{\frac{{τ}_{1} + {τ}_{2}}{{τ}_{2}}}}\end{matrix} \qquad ( 8 )$$

wherein φ(ωₘ) is a maximum lead angle provided by the power correction stage, and ωₘ is an angular frequency corresponding to the maximum lead angle.
wherein the cutoff frequency and system's phase margin can be derived from formula (6), with the expression shown in formula (9):

$$\{ \begin{matrix}\vert \frac{\vert {G}_{2} ( s ) \vert \sqrt{{( ( {τ}_{1} + {τ}_{2} ) {ω}_{c} )}^{2} + 1}}{\sqrt{{( J {ω}_{0} {ω}_{c} )}^{2} + {( {D}_{p} {ω}_{0} )}^{2}} \cdot \sqrt{{( {τ}_{1} {ω}_{c} )}^{2} + 1}} \vert = 1 \\ γ = 180 ° - arctan \frac{J {ω}_{c}}{{D}_{p}} + ∠ {G}_{2} ( {ω}_{c} ) + φ ( {ω}_{c} )\end{matrix} \qquad ( 9 )$$

wherein ω_{c} is the cutoff frequency of the VSG system after adding active power correction, φ(ω_{c}) is the corresponding phase angle at this cutoff frequency after adding power correction, the specific expression is:

$$φ ( {ω}_{c} ) = arctan \frac{{τ}_{2} {ω}_{c}}{1 + {τ}_{1} ( {τ}_{1} + {τ}_{2} ) {ω}_{c}^{2}} \qquad ( 10 )$$

In order to fully utilize the maximum lead angle provided by the power correction stage, setting ω_{c}=ωₘ, and substituting formula (8) and (10) into formula (9) to obtain the binary formula s for τ₁ and τ₂ as shown in formulas (11) and (12):

$${τ}_{1} = \sqrt{\frac{\begin{matrix}{D}_{p}^{2} \frac{{τ}_{1} + {τ}_{2}}{{τ}_{1}} + \\ \sqrt{{( {D}_{p} {ω}_{0} )}^{4} {( \frac{{τ}_{1} + {τ}_{2}}{{τ}_{1}} )}^{2} + 4 {\vert {G}_{2} ( s ) \vert}^{2} {( \frac{{τ}_{1} + {τ}_{2}}{{τ}_{1}} )}^{3} {( J {ω}_{0} )}^{2}}\end{matrix}}{2 {\vert {G}_{2} ( s ) \vert}^{2} {( \frac{{τ}_{1} + {τ}_{2}}{{τ}_{1}} )}^{3}}} \qquad ( 11 )$$

$${τ}_{1} = \frac{J {ω}_{0}}{{D}_{p} {ω}_{0}} \frac{2 {( \frac{{τ}_{1} + {τ}_{2}}{{τ}_{1}} )}^{\frac{1}{2}}}{{( \frac{{τ}_{1} + {τ}_{2}}{{τ}_{1}} )}^{\frac{3}{2}} + 2 cot γ - {( \frac{{τ}_{1} + {τ}_{2}}{{τ}_{1}} )}^{\frac{1}{2}}} \qquad ( 12 )$$

Generally, the larger the system's phase margin, the more stable the system becomes; however, an excessive phase margin will slow down the system response speed. Therefore, after comprehensive consideration, the present application selects a phase margin of γ=35°. By combining formulas (11) and (12), the specific values of parameters τ₁ and τ₂ can be determined.

To verify the effectiveness of the method proposed in the present application, the main circuit topology and control structure model of the Virtual Synchronous Generator (VSG) system as shown in FIG. 5 were built in Matlab/Simulink. The system parameters are specified in Table 1.

TABLE 1
Specific Parameters of the VSG System

| Parameter | Symbol | Value | |
|---|---|---|---|
| DC Voltage | V_{dc} | 700 | V |
| Grid Voltage | U_{g} | 220 | V |
| Switching Frequency | fₛ | 10 | kHz |
| Fundamental Frequency | f₀ | 50 | Hz |
| Filter Inductance | L_{f} | 0.5 | mH |
| Filter Capacitance | C_{f} | 50 | μF |
| Damping Resistance | R_{c} | 0.2Ω | |
| Line Inductance | L_{g} | 0.5 | mH |
| Active Power Reference Value | P_{ref} | 3 | kW |
| Reactive Power Reference Value | Q_{ref} | 0 | var |
| Virtual Inertia | J | 2 | kg · m² |
| Damping Coefficient | Dₚ | 1000 | W · s/rad |
| Reactive Virtual Inertia Coefficient | k_{q} | 5 | mV/var |

| | | |
|---|---|---|
| Modulation coefficient | D_{q} | 321 |

Two groups of comparative experiments were established: one without correction and one with the correction strategy proposed in the present application. The VSG output transient response was observed when the grid frequency and reference power were disturbed, and frequency domain analysis was conducted based on system response performance indicators.

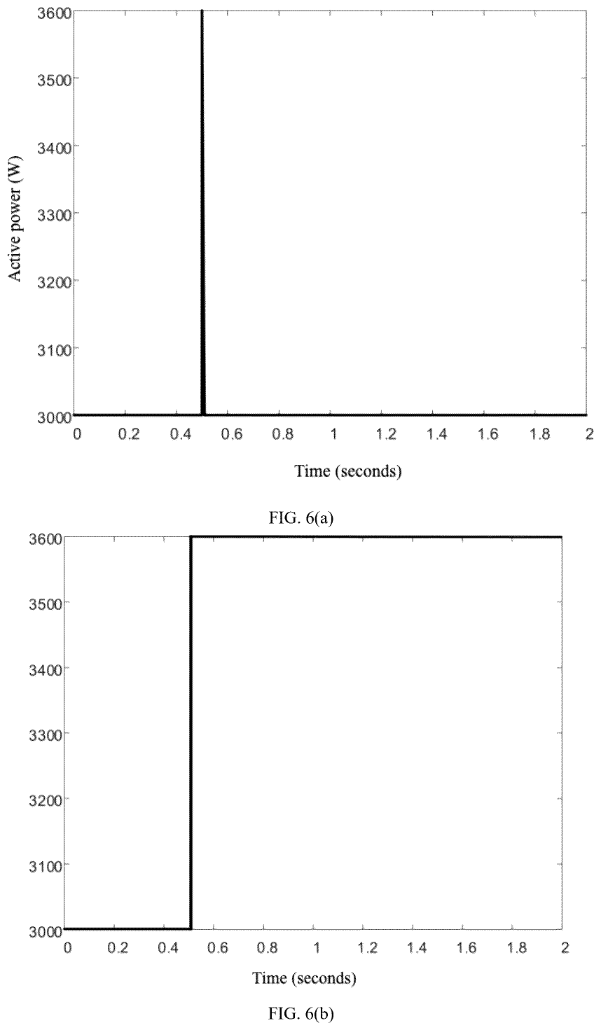

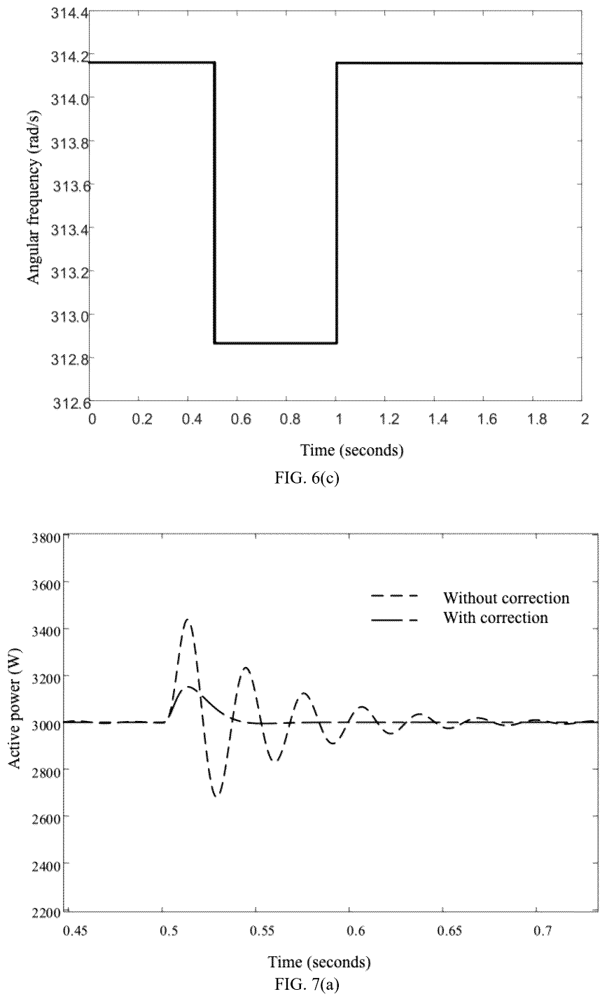

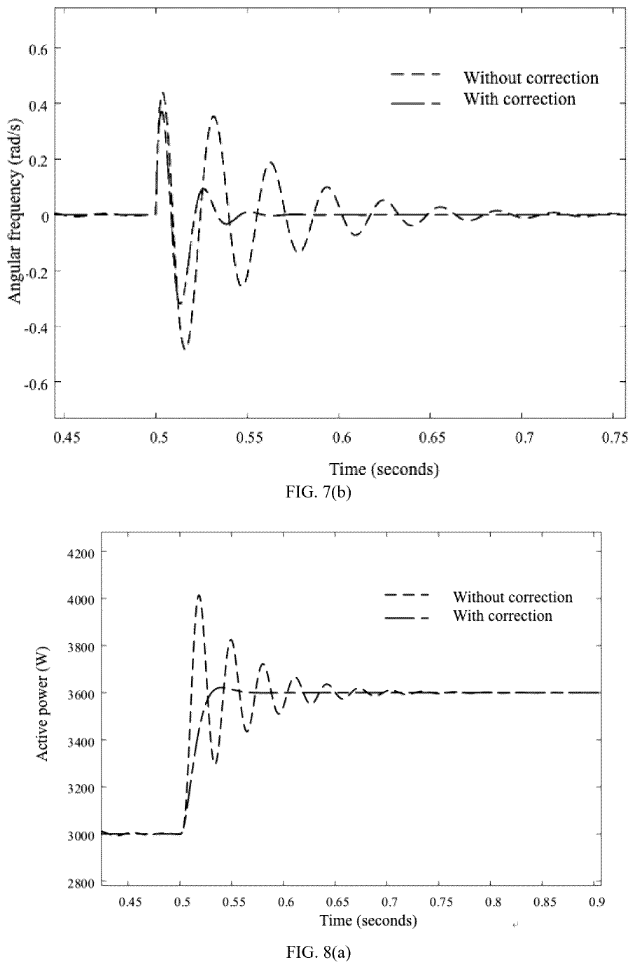

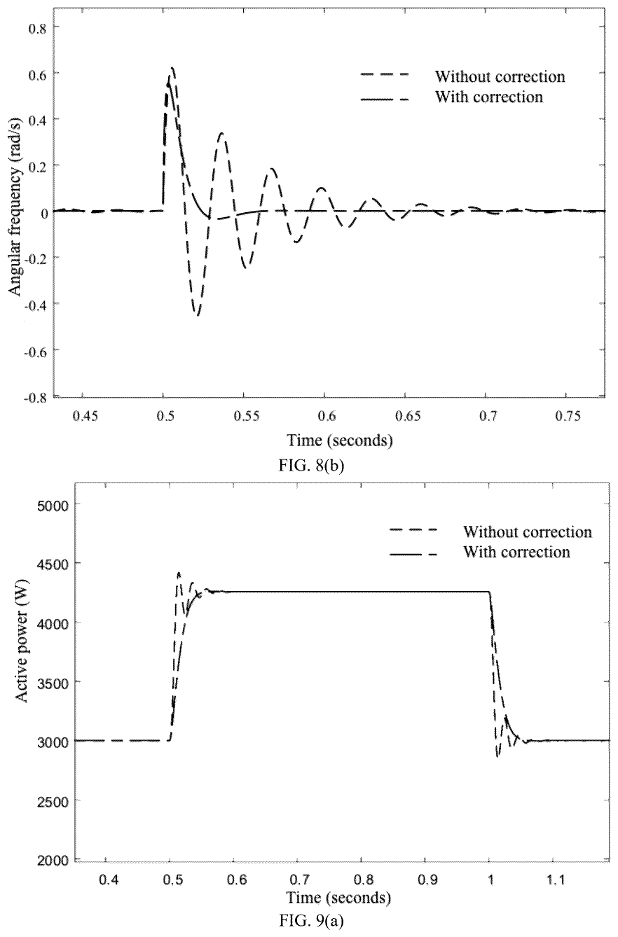

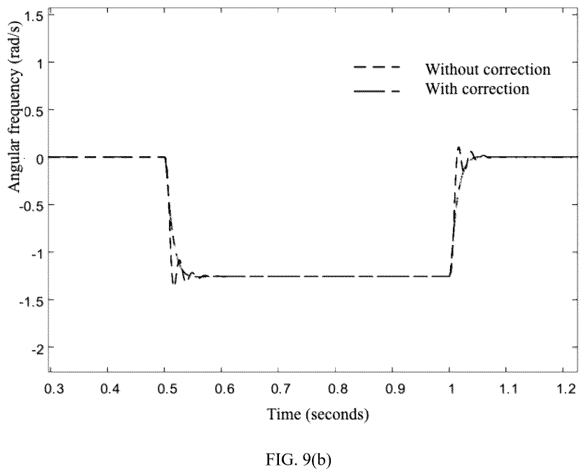

FIGS. 6(a), 6(b), and 6(c) show the operating conditions under reference power impact, reference power step, and grid angular frequency step in the method of the present application; FIGS. 7(a) and 7(b) show the VSG output power and output angular frequency responses, respectively, during reference power impact in the method of the present application; FIGS. 8(a) and 8(b) show the VSG output power and output angular frequency responses, respectively, during reference power step in the method of the present application; FIG. 9(a) and FIG. 9(b) show the VSG output power and output angular frequency response, respectively, when the grid angular frequency undergoes a step in the present application method. FIGS. 7(a), 7(b), 8(a), and 8(b) demonstrate that whether under reference power impact or reference power step, after implementing the correction control strategy of the present application, both the overshoot and adjustment time of the VSG system output power and angular frequency are reduced, confirming the effectiveness of the control strategy presented in the present application; FIGS. 9(a) and 9(b) show that although the peak value of output power decreases slightly at the moment of disturbance and the system's inertial response capability is somewhat reduced, the magnitude of this reduction is not significant and can be considered negligible compared to the advantages gained from the substantially reduced system oscillations, indicating that this correction strategy can also demonstrate excellent support capability during grid frequency disturbances.

In summary, the experimental results verify the correctness of the method proposed in the present application, which can dynamically correct the system when power oscillation occurs in Virtual Synchronous Generator (VSG) output to maintain system stability performance and obtain greater inertia support.

In the VSG control loop of the present application, the output power Pc(s) is obtained and multiplied by the correction stage G(s) before being fed back to the frequency generation stage of the active power-frequency control loop, thereby suppressing power oscillation and increasing system robustness; According to the active power-frequency control stage in the VSG control loop, the expression of frequency ω is obtained, and the added frequency generation stage is compensated into the control loop, thus deriving the new expression of ω*; Determine the specific expression of the power correction stage G(s), and design the parameters τ₁ and τ₂ in the power correction stage G(s) based on the phase margin requirements of the system open-loop transfer function; verify the correctness of the proposed correction strategy through experiments. The present application enhances the anti-interference capability of Virtual Synchronous Generator (VSG) by adding structures such as power correction to the VSG control loop, which provides a new approach for enhancing the stability of the VSG system. The expression of its power correction stage G(s) is flexible and can be configured with appropriate parameters according to the system's phase margin. The adjustment coefficients τ₁ and τ₂ of the power correction stage do not affect the steady-state gain and only take effect during the transient process. It can suppress the power oscillation of Virtual Synchronous Generator (VSG) output while simultaneously enhancing the system's inertia support capability. Compared with VSG systems without correction, the system's anti-interference performance is significantly improved after adding correction, and the ability to suppress overshoot is significantly enhanced.

### Embodiment Two

An electronic device, comprising a memory and a processor, wherein the memory stores programs that enable the processor to execute the VSG frequency control method based on power correction described in Embodiment 1, and the processor is configured to execute the program stored in the memory.

### Embodiment Three

A storage medium storing a computer program, wherein when executed by a processor, the computer program performs the steps of the VSG frequency control method based on power correction described in Embodiment 1.

The above embodiments are only used to explain the technical solution of the present application, not to limit it; Although the invention has been described in detail with reference to the foregoing embodiments, those skilled in the art should understand that they can still modify the technical solutions described in the preceding embodiments, or replace some technical features with equivalents; and these modifications or replacements do not cause the essence of the corresponding technical solutions to deviate from the spirit and scope of the technical solutions of the various embodiments of the present application.

1. A Virtual Synchronous Generator (VSG) frequency control method based on power correction, comprising the following steps:
S1. obtaining an output power Pₑ(s) in the VSG control loop, multiplying the out power by a transfer function G(s) of a correction stage, and feeding it back to a frequency generation stage of an active power-frequency control loop, wherein Pₑ(s) refers to an output power at a VSG grid connection point, obtained through sampling and calculation;
S2. obtaining a frequency ω according to the active power-frequency control stage in the VSG control loop, and compensating the frequency generation stage from the step S1 into the control loop to obtain a compensated frequency ω*;
S3. designing the parameters of coefficients τ₁ and τ₂ in the transfer function G(s) of the power correction stage based on the transfer function G(s) of the power correction stage and in combination with the phase margin requirements of a system open-loop transfer function.

2. The Virtual Synchronous Generator (VSG) frequency control method based on power correction according to claim 1, wherein a calculation formula of the output power Pₑ(s) is:
$${P}_{e} ( s ) = \frac{3}{2} ( {e}_{d} {i}_{d} + {e}_{q} {i}_{q} ) \qquad ( 1 )$$
wherein e_{d}, e_{q}, i_{d}, and i_{q} are the d-axis and q-axis components of the voltage and current at the sampling point PCC after abc/dq0 transformation, and s is the transformation parameter in the Laplace transform.

3. The Virtual Synchronous Generator (VSG) frequency control method based on power correction according to claim 1, wherein the expression of the frequency ω is:
$$ω = ( {P}_{ref} ( s ) - {P}_{e} ( s ) ) \frac{1}{J {ω}_{0} s + {D}_{p} {ω}_{0}} + {ω}_{0} \qquad ( 2 )$$
wherein J is a virtual inertia coefficient, Dₚ is a damping coefficient, P_{ref}(s) is a reference power, and ω₀ is a grid rated angular frequency.

4. The Virtual Synchronous Generator (VSG) frequency control method based on power correction according to claim 3, wherein the expression of the compensated frequency ω* is:
$${ω}^{*} = ( {P}_{ref} ( s ) - {P}_{e} ( s ) ) \frac{1}{J {ω}_{0} s + {D}_{p} {ω}_{0}} + {ω}_{0} - {P}_{e} ( s ) G ( s ) \qquad ( 3 )$$
wherein G(s) is a transfer function of the correction stage.

5. The Virtual Synchronous Generator (VSG) frequency control method based on power correction according to claim 4, wherein the expression of transfer function of the correction stage is:
$$G ( s ) = \frac{- {τ}_{2} s}{( 1 + {τ}_{1} s + {τ}_{2} s ) {G}_{2} ( s )} \qquad ( 4 )$$
wherein τ₁ and τ₂ are regulation coefficients of the power correction stage, and G₂(s) is a transfer function from an angular frequency Δω in a Virtual Synchronous Generator (VSG) small-signal model to output power Pₑ(s).

6. The Virtual Synchronous Generator (VSG) frequency control method based on power correction according to claim 5, wherein the expression of the transfer function G₂(s) from the angular frequency Δω in the Virtual Synchronous Generator (VSG) small-signal model to output power Pₑ(s) is:
$${G}_{2} ( s ) = \frac{{K}_{s} ( s )}{s} = \frac{\frac{3 E {U}_{g}}{\sqrt{{( s {L}_{X} + {R}_{X} )}^{2} + {( {ω}_{0} {L}_{X} )}^{2}}}}{s} \qquad ( 5 )$$
wherein, L_{X} is the sum of filter inductance L_{f} and transmission line inductance L_{g}, R_{X} is the sum of the resistances in transmission line, E is a VSG output voltage amplitude, and U_{g} is a grid-side voltage.

7. The Virtual Synchronous Generator (VSG) frequency control method based on power correction according to claim 6, wherein the expression of the system open-loop transfer function is:
$${G}_{open} ( s ) = \frac{1}{( J {ω}_{0} s + {D}_{p} {ω}_{0} )} {G}_{2} ( s ) \frac{1 + ( {τ}_{1} + {τ}_{2} ) s}{1 + {τ}_{1} s} \qquad ( 6 )$$
wherein the system's phase margin is expressed as:
$$P M = 180 ° + ∠ [ {G}_{open} ( s ) ] \qquad ( 7 )$$
wherein using the system's phase margin as an indicator to design the parameters of the adjustment coefficients τ₁ and τ₂ of the power correction stage.

8. The Virtual Synchronous Generator (VSG) frequency control method based on power correction according to claim 7, wherein the process for designing the parameters of the adjustment coefficients τ₁ and τ₂ of the power correction stage is as follows:
equivalently representing the power correction stage as a lead-lag compensator, with its characteristic expressed as:
$$\{ \begin{matrix}φ ( {ω}_{m} ) = arctan \frac{\frac{{τ}_{2}}{{τ}_{1}}}{2 \sqrt{\frac{{τ}_{1} + {τ}_{2}}{{τ}_{1}}}} \\ {ω}_{m} = \frac{1}{{τ}_{1} \sqrt{\frac{{τ}_{1} + {τ}_{2}}{{τ}_{2}}}}\end{matrix} \qquad ( 8 )$$
wherein φ(ωₘ) is a maximum lead angle provided by the power correction stage, and ωₘ is an angular frequency corresponding to the maximum lead angle;
wherein the cutoff frequency and system's phase margin can be derived from formula (6), with the expression shown in formula (9):
$$\{ \begin{matrix}\vert \frac{\vert {G}_{2} ( s ) \vert \sqrt{{( ( {τ}_{1} + {τ}_{2} ) {ω}_{c} )}^{2} + 1}}{\sqrt{{( J {ω}_{0} {ω}_{c} )}^{2} + {( {D}_{p} {ω}_{0} )}^{2}} \cdot \sqrt{{( {τ}_{1} {ω}_{c} )}^{2} + 1}} \vert = 1 \\ γ = 180 ° - arctan \frac{J {ω}_{c}}{{D}_{p}} + ∠ {G}_{2} ( {ω}_{c} ) + φ ( {ω}_{c} )\end{matrix} \qquad ( 9 )$$
wherein ω_{c} is the cutoff frequency of the VSG system after adding active power correction, φ(ω_{c}) is the corresponding phase angle at this cutoff frequency after adding power correction, the specific expression is:
$$φ ( {ω}_{c} ) = arctan \frac{{τ}_{2} {ω}_{c}}{1 + {τ}_{1} ( {τ}_{1} + {τ}_{2} ) {ω}_{c}^{2}} \qquad ( 10 )$$
setting ω_{c}=ωₘ, and substituting formula (8) and (10) into formula (9) to obtain the binary formula s for τ₁ and τ₂ as shown in formulas (11) and (12):
$${τ}_{1} = \sqrt{\frac{\begin{matrix}{D}_{p}^{2} \frac{{τ}_{1} + {τ}_{2}}{{τ}_{1}} + \\ \sqrt{{( {D}_{p} {ω}_{0} )}^{4} {( \frac{{τ}_{1} + {τ}_{2}}{{τ}_{1}} )}^{2} + 4 {\vert {G}_{2} ( s ) \vert}^{2} {( \frac{{τ}_{1} + {τ}_{2}}{{τ}_{1}} )}^{3} {( J {ω}_{0} )}^{2}}\end{matrix}}{2 {\vert {G}_{2} ( s ) \vert}^{2} {( \frac{{τ}_{1} + {τ}_{2}}{{τ}_{1}} )}^{3}}} \qquad ( 11 )$$
$${τ}_{1} = \frac{J {ω}_{0}}{{D}_{p} {ω}_{0}} \frac{2 {( \frac{{τ}_{1} + {τ}_{2}}{{τ}_{1}} )}^{\frac{1}{2}}}{{( \frac{{τ}_{1} + {τ}_{2}}{{τ}_{1}} )}^{\frac{3}{2}} + 2 cot γ - {( \frac{{τ}_{1} + {τ}_{2}}{{τ}_{1}} )}^{\frac{1}{2}}} \qquad ( 12 )$$
selecting the phase margin γ, combine formula s (11) and (12) to determine the specific values of parameters τ₁ and τ₂.

9. (canceled)

10. (canceled)
